(19) United States
(12) Patent Application Publication
(10) Pub. No.: US 2022/0037931 A1
(43) Pub. Date: Feb. 3, 2022

(54) FOREIGN SUBSTANCE DETECTION DEVICE, ELECTRIC POWER TRANSMISSION DEVICE, ELECTRIC POWER RECEPTION DEVICE, AND ELECTRIC POWER TRANSMISSION SYSTEM

(71) Applicant: TDK CORPORATION, Tokyo (JP)

(72) Inventor: Akira GOTANI, Tokyo (JP)

(73) Assignee: TDK CORPORATION, Tokyo (JP)

(21) Appl. No.: 17/364,955

(22) Filed: Jul. 1, 2021

(30) Foreign Application Priority Data
Jul. 29, 2020 (JP) 2020-128603

(51) Int. Cl. H02J 50/60; H02J 50/12; B60L 53/124

(52) U.S. Cl. CPC H02J 50/60; H02J 50/80; B60L 53/124; H02J 50/12

(57) ABSTRACT

In a case in which an excess sensor which is a sensor in which the value for comparison exceeds the threshold value is present in one of the consecutive comparison processes, the detector determines that a foreign substance is present when the number of times of excess, which is the number of times at which the value for comparison exceeds the threshold value in the excess sensor reaches the first number of times. In a case in which the excess sensors of which the number is a first count that is more than one are present in one of the consecutive comparison processes, the detector determines that the foreign substance is present when the number of times of excess in each of the excess sensors of which the number is the first count reaches the second number of times, which is less than the first number of times.

### CROSS-REFERENCE TO RELATED APPLICATION

This application claims the benefit of Japanese Patent Application No. 2020-128603, filed on Jul. 29, 2020, the entire disclosure of which is incorporated by reference herein.

### FIELD

The present disclosure relates to a foreign substance detection device, an electric power transmission device, an electric power reception device, and an electric power transmission system.

### BACKGROUND

Wireless electric power transmission technologies, by which electric power is wirelessly transmitted, have received attention. The wireless electric power transmission technologies enable electric power to be wirelessly transmitted from an electric power transmission device to an electric power reception device, and are therefore expected to be applied to various products such as transportation equipment such as trains and electric vehicles, household electric appliances, radio communication equipment, and toys. In the wireless electric power transmission technologies, an electric power transmission coil and an electric power reception coil, linked by a magnetic flux, are used for transmitting electric power.

When a foreign substance, of which examples include metal pieces, is present in the vicinities of the electric power transmission coil and the electric power reception coil, various problems may occur. For example, such a foreign substance may adversely affect transmission of power from the electric power transmission coil to the electric power reception coil, or may result in eddy current, whereby heat may be generated. Accordingly, a technology to appropriately detect a foreign substance present in the vicinities of the electric power transmission coil and the electric power reception coil is desired.

Patent Literature 1 describes an electric power reception device that stops reception of electric power when two pyroelectric sensors detect a foreign substance, and that notifies a user of detection of a foreign substance when one pyroelectric sensor detects the foreign substance. Patent Literature 2 describes a non-contact power feeding device that compares a potential difference between a voltage between both ends of a battery and a voltage between both ends of a capacitor for smoothing with a determination threshold value to detect abnormal power feeding caused by the presence of a foreign substance. When the potential difference exceeds the determination threshold value at the specified number of times, the non-contact power feeding device determines that the abnormal power feeding occurs, that is, the foreign substance is present.

### SUMMARY

In the case of detecting a foreign substance, reduced occurrence of false detection is desired. Moreover, it is desired that a specific foreign substance can be immediately detected. The specific foreign substance is, for example, a large foreign substance that is considered to greatly influence transmission of electric power and to result in the large amount of generated heat, and/or the like. However, it is difficult to improve a speed at which the specific foreign substance is detected while suppressing false detection, in both the electric power reception device described in Patent Literature 1 and the non-contact power feeding device described in Patent Literature 2.

For example, the electric power reception device described in Patent Literature 1 determines that a foreign substance is present when the output voltage of at least one pyroelectric sensor exceeds a threshold value even once due to the influence of noise even in a case in which the foreign substance is absent. In other words, false detection is highly likely to occur in the electric power reception device described in Patent Literature 1. In the non-contact power feeding device described in Patent Literature 2, the small specified number of times results in the increased risk of false detection while the large specified number of times results in the need for time to detect a foreign substance. Therefore, it is difficult to achieve both the suppression of the false detection and the improvement in the detection speed, in the non-contact power feeding device described in Patent Literature 2.

The present disclosure was made in view of the problems described above, with an objective of improving a speed at which a specific foreign substance is detected while suppressing false detection, in wireless electric power transmission.

To solve the problems described above, a foreign substance detection device according to one embodiment of the present disclosure includes:

a plurality of sensors; and

a detector that repeatedly executes consecutive comparison processes in which individual comparison processes of comparing values for comparison based on output values from the sensors and a threshold value are executed in predetermined order for the plurality of sensors, and that determines presence or absence of a foreign substance based on comparison results of the individual comparison processes, wherein

in a case in which an excess sensor which is a sensor in which the value for comparison exceeds the threshold value is present among the plurality of sensors in one of the consecutive comparison processes, the detector determines that the foreign substance is present when a number of times of excess, which is a number of times at which the value for comparison exceeds the threshold value in the excess sensor reaches a first number of times; and in a case in which the excess sensors of which a number is a first count that is more than one are present in one of the consecutive comparison processes, the detector determines that the foreign substance is present when the number of times of excess in each of the excess sensors of which the number is the first count reaches a second number of times, which is less than the first number of times.

In accordance with the foreign substance detection device including such a structure as described above, the speed at which the specific foreign substance is detected can be improved while suppressing the false detection, in the wireless electric power transmission.

### BRIEF DESCRIPTION OF THE DRAWINGS

A more complete understanding of this application can be obtained when the following detailed description is considered in conjunction with the following drawings, in which:

FIG. 1 is a schematic configuration view of an electric power transmission system according to Embodiment 1;

FIG. 2 is an arrangement drawing of a foreign substance detection device according to Embodiment 1;

FIG. 3 is an explanatory diagram of the arrangement of a detection coil unit according to Embodiment 1;

FIG. 4 is a plan view of a detection coil unit according to Embodiment 1;

FIG. 5 illustrates an equivalent circuit of a resonant circuit included in the detection coil unit according to Embodiment 1;

FIG. 6 is a configuration view of a detector included in the foreign substance detection device according to Embodiment 1;

FIG. 7 is a first graph indicating a correspondence relationship between the number of measurements and a difference value;

FIG. 8 is a second graph indicating a correspondence relationship between the number of measurements and a difference value;

FIG. 9 is a flow chart illustrating a foreign substance detection process executed by the foreign substance detection device according to Embodiment 1;

FIG. 10 is a flow chart illustrating an individual comparison process illustrated in FIG. 9;

FIG. 11 is a flow chart illustrating a foreign substance detection process executed by a foreign substance detection device according to Embodiment 2;

FIG. 12 is a flow chart illustrating a foreign substance detection process executed by the foreign substance detection device according to Embodiment 3;

FIG. 13 is a flow chart illustrating specific consecutive comparison processes illustrated in FIG. 12;

FIG. 14 is a flow chart illustrating a foreign substance detection process executed by the foreign substance detection device according to Embodiment 4;

FIG. 15 is a flow chart illustrating a loop coil selection process illustrated in FIG. 14; and

FIG. 16 is an arrangement drawing of a foreign substance detection device according to Embodiment 5.

### DETAILED DESCRIPTION

Electric power transmission systems according to embodiments of the present disclosure will be described below with reference to the drawings. In the following embodiments, the same components are denoted by the same reference characters. The ratios of the sizes, and shapes of components illustrated in each drawing are not necessarily identical to those in practice.

### Embodiment 1

The electric power transmission system according to the present embodiment can be utilized in charge of the secondary batteries of various devices such as electric vehicles (EV), mobile devices such as smartphones, and industrial equipment. An example of a case in which the electric power transmission system executes charge of the storage battery of an EV will be described below.

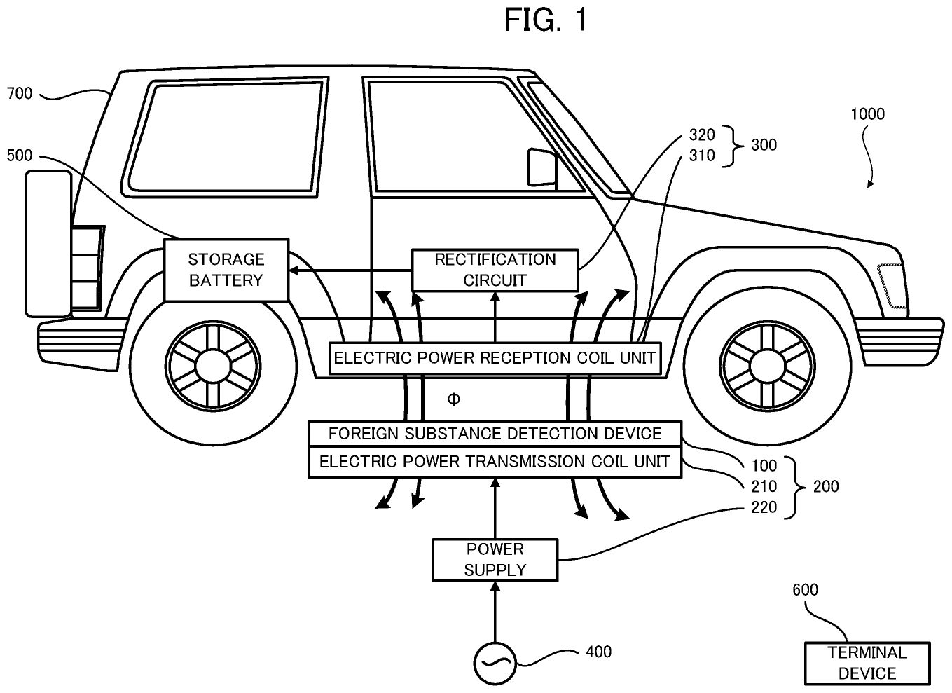

FIG. 1 is a view illustrating the schematic configuration of an electric power transmission system 1000 used in charge of a storage battery 500 included in an electric vehicle 700. The electric vehicle 700 travels using, as a power source, a motor driven by electric power charged in the storage battery 500 such as a lithium-ion battery or a lead storage battery.

As illustrated in FIG. 1, the electric power transmission system 1000 is a system that wirelessly transmits electric power from an electric power transmission device 200 to an electric power reception device 300 by magnetic coupling. The electric power transmission system 1000 includes: the electric power transmission device 200 that wirelessly transmits electric power from an alternating-current or direct-current commercial power source 400 to the electric vehicle 700; and the electric power reception device 300 that receives the electric power transmitted by the electric power transmission device 200 and charges the storage battery 500. In the present embodiment, the commercial power source 400 is an alternating-current power source.

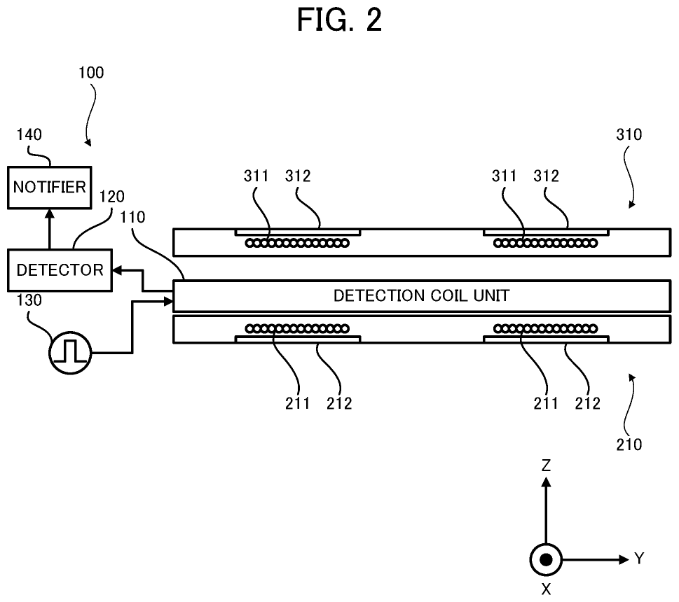

The electric power transmission device 200 is a device that wirelessly transmits electric power to the electric power reception device 300 by magnetic coupling. The electric power transmission device 200 includes: a foreign substance detection device 100 that detects a foreign substance; an electric power transmission coil unit 210 that transmits alternating-current power to the electric vehicle 700; and a power supply 220 that supplies alternating-current power to the electric power transmission coil unit 210. As illustrated in FIG. 2, the foreign substance detection device 100 is arranged on the electric power transmission coil unit 210. In FIG. 2, an upward axis in a vertical direction is the Z-axis, an axis orthogonal to the Z-axis is the X-axis, and an axis orthogonal to the Z-axis and the X-axis is the Y-axis. The details of the foreign substance detection device 100 will be described later.

As illustrated in FIG. 2, the electric power transmission coil unit 210 includes: an electric power transmission coil 211 that induces an alternate magnetic flux Φ in response to supply of alternating-current power the from power supply 220; and a magnetic substance plate 212 through which magnetic force generated by the electric power transmission coil 211 is allowed to pass, to suppress loss of the magnetic force. The electric power transmission coil 211 is formed by spirally winding a conductive wire on the magnetic substance plate 212. The electric power transmission coil 211 and capacitors disposed on both respective ends of the electric power transmission coil 211 form a resonance circuit, which induces an alternate magnetic flux Φ due to flow of alternating current in response to application of alternating voltage.

The magnetic substance plate 212 has the shape of a plate with a central portion in which a hole is opened. The magnetic substance plate 212 is formed of a magnetic substance. The magnetic substance plate 212 is, for example, a plate-shaped member formed of ferrite which is a composite oxide of iron oxide and a metal. The magnetic substance plate 212 may be formed of an aggregate of a plurality of magnetic substance pieces, or may be formed so that the central portion of the magnetic substance plate 212 includes an opening by arranging the plurality of magnetic substance pieces in a frame form.

The power supply 220 includes: a power-factor improvement circuit that improves the power factor of commercial alternating-current power supplied by the commercial power source 400; and an inverter circuit that generates alternating-current power to be supplied to the electric power transmission coil 211. The power-factor improvement circuit rectifies and boosts the alternating-current power generated by the commercial power source 400, and converts the alternating-current power into direct-current power having a predetermined voltage value. The inverter circuit converts, into alternating-current power having a predetermined frequency, the direct-current power generated by converting the electric power by the power-factor improvement circuit. The electric power transmission device 200 is fixed on, for example, the floor surface of a parking place.

The electric power reception device 300 is a device that wirelessly receives electric power from the electric power transmission device 200 by magnetic coupling. The electric power reception device 300 includes: an electric power reception coil unit 310 to receive alternating-current power transmitted by the electric power transmission device 200; and a rectification circuit 320 that converts, into direct-current power, the alternating-current power supplied from the electric power reception coil unit 310, and supplies the direct-current power to the storage battery 500.

As illustrated in FIG. 2, the electric power reception coil unit 310 includes: an electric power reception coil 311 that induces electromotive force in response to change in alternate magnetic flux Φ induced by the electric power transmission coil 211; and a magnetic substance plate 312 through which magnetic force generated by the electric power reception coil 311 is allowed to pass, to suppress loss of the magnetic force. The electric power reception coil 311 and capacitors disposed on both respective ends of the electric power reception coil 311 form a resonance circuit. The electric power reception coil 311 faces the electric power transmission coil 211 in a state in which the electric vehicle 700 stops at a position set in advance. When the electric power transmission coil 211 induces an alternate magnetic flux Φ in response to reception of electric power from the power supply 220, the alternate magnetic flux Φ crosses the electric power reception coil 311, whereby induced electromotive force is induced in the electric power reception coil 311.

The magnetic substance plate 312 has the shape of a plate with a central portion in which a hole is opened. The magnetic substance plate 312 is formed of a magnetic substance. The magnetic substance plate 312 is, for example, a plate-shaped member formed of ferrite which is a composite oxide of iron oxide and a metal. The magnetic substance plate 312 may be formed of an aggregate of a plurality of magnetic substance pieces, or may be formed so that the central portion of the magnetic substance plate 312 includes an opening by arranging the plurality of magnetic substance pieces in a frame form.

The rectification circuit 320 rectifies the electromotive force induced in the electric power reception coil 311, to generate direct-current power. The direct-current power generated by the rectification circuit 320 is supplied to the storage battery 500. The electric power reception device 300 may include a charging circuit that converts direct-current power supplied from the rectification circuit 320, into direct-current power suitable for charging the storage battery 500, between the rectification circuit 320 and the storage battery 500. The electric power reception device 300 is fixed on, for example, the chassis of the electric vehicle 700.

A terminal device 600 is a device that is notified of the presence of a foreign substance from the foreign substance detection device 100. The terminal device 600 is, for example, a smartphone possessed by the owner of the electric vehicle 700. The terminal device 600 notifies a user of the presence of the foreign substance through screen display, voice output, or the like when being notified of the presence of the foreign substance from the foreign substance detection device 100.

The foreign substance detection device 100 detects a foreign substance present in a region for detection. The region for detection is a region for detecting a foreign substance, and is a region in which a foreign substance can be detected. The region for detection is a region in the vicinities of the electric power transmission coil unit 210 and the electric power reception coil unit 310, and is a region including an area between the electric power transmission coil unit 210 and the electric power reception coil unit 310. The foreign substance is an object or living body undesired for transmitting electric power.

The foreign substance may adversely affect transmission of electric power or may result in generation of heat when being arranged in the region for detection in the transmission of electric power. Thus, the foreign substance detection device 100 detects the foreign substance present in the region for detection, and notifies the user of the presence of the foreign substance. When receiving this notification, the user can remove the foreign substance. Possible examples of the foreign substance include various foreign substances such as metal pieces, humans, and animals. As illustrated in FIG. 2, the foreign substance detection device 100 includes a detection coil unit 110, a detector 120, a pulse generator 130, and a notifier 140.

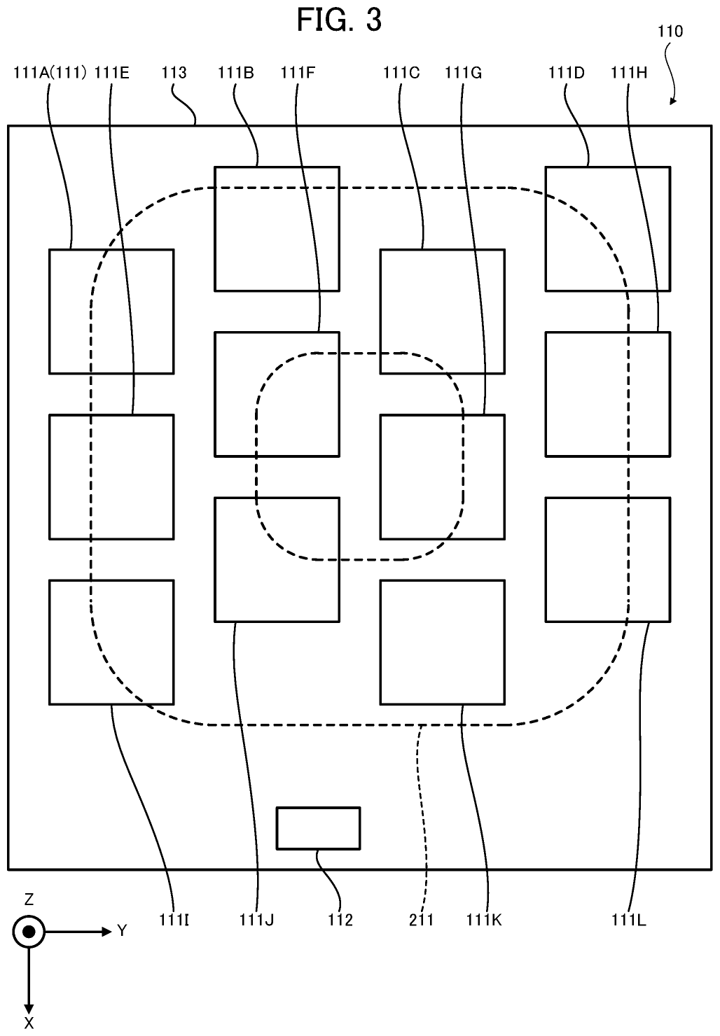

The detection coil unit 110 is a unit in which loop coils 111 that detect a foreign substance are integrated. As illustrated in FIG. 3, the detection coil unit 110 is formed in a flat-plate shape, and is arranged on the electric power transmission coil unit 210 so as to overlap the electric power transmission coil 211 in planar view. The detection coil unit 110 includes a detection coil substrate 113 formed of a material with magnetic permeability, of which examples include a resin. The detection coil substrate 113 is provided with: the twelve loop coils 111 arranged in an XY plane form; and an external connection connector 112 through which each loop coil 111, the detector 120, and the pulse generator 130 are connected. The loop coils 111 are sensors for detecting a foreign substance 10.

The detector 120 determines whether or not a foreign substance is present in a region for detection on the basis of output values from the loop coils 111 excited by applying pulsing voltage. The pulse generator 130 generates pulsing voltage for detecting a foreign substance, selects a loop coil 111, and applies the pulsing voltage to the loop coil 111. When the foreign substance is detected by the detector 120, the notifier 140 notifies the user of the detection of the foreign substance. For example, the notifier 140 transmits information, representing the detection of the foreign substance, to the terminal device 600 possessed by the user.

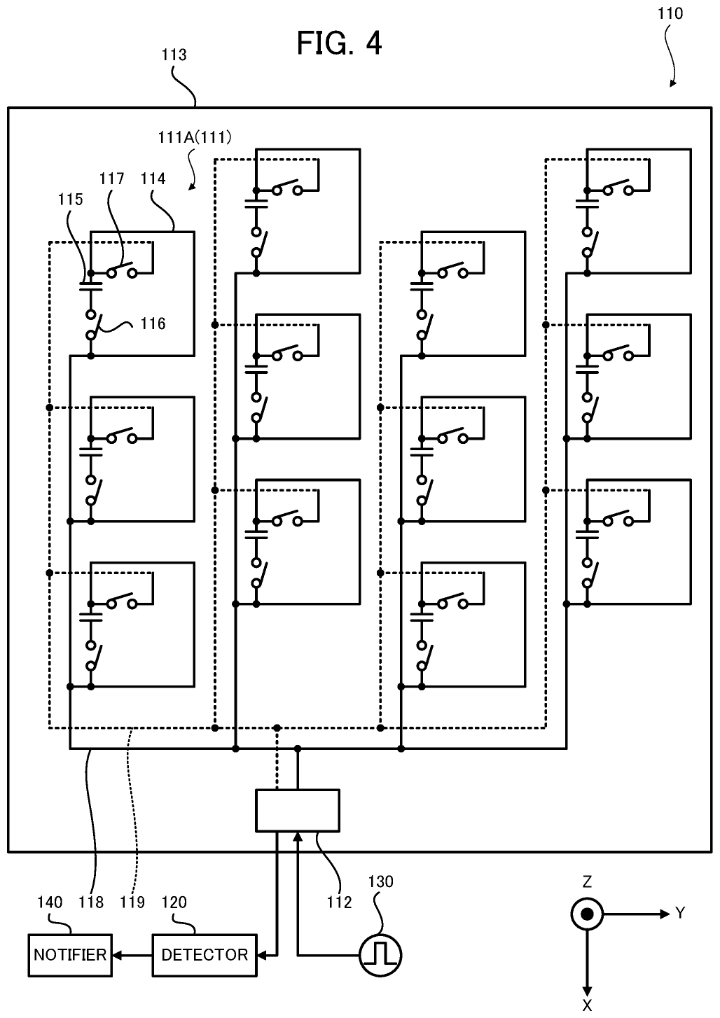

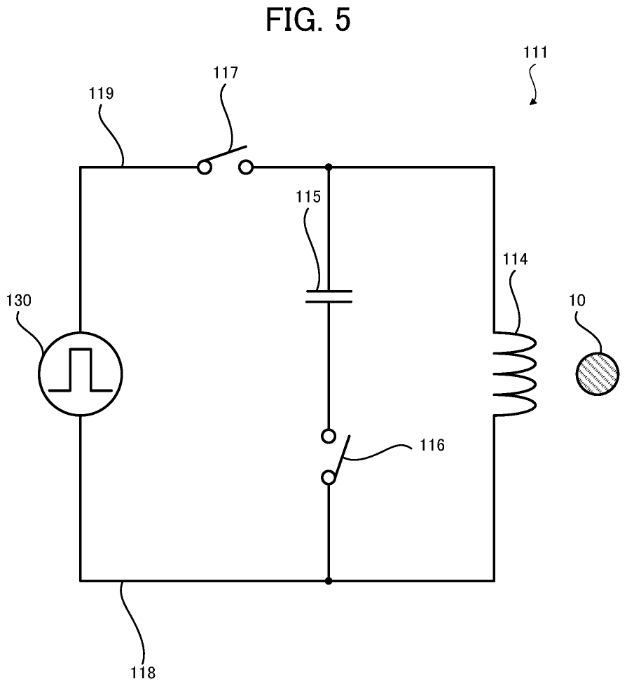

The structure of the loop coil 111 will now be described in detail with reference to FIG. 4 and FIG. 5. The loop coil 111 is the collective term of the twelve loop coils 111 which are a loop coil 111A, a loop coil 111B, a loop coil 111C, a loop coil 111D, a loop coil 111E, a loop coil 111F, a loop coil 111G, a loop coil 111H, a loop coil 111I, a loop coil 111J, a loop coil 111K, and a loop coil 111L. The twelve loop coils 111 have substantially similar structures. The loop coil 111 includes a coil 114, a capacitor 115, a switch 116, and a switch 117. In FIG. 4, only the loop coil 111A is denoted by the reference character in consideration of easiness in seeing of the drawing.

The coil 114 includes a conductor pattern in which winding about an axis parallel to the Z-axis on the upper surface of the detection coil substrate 113 is performed once or a plurality of times. One terminal of the coil 114 is connected to one terminal of the switch 116 and to a first connection wiring line 118. The first connection wiring line 118 is disposed on the upper surface of the detection coil substrate 113, and connected to the external connection connector 112. The other terminal of the coil 114 is connected to one terminal of the capacitor 115 and to one terminal of the switch 117. The other terminal of the switch 117 is connected to a second connection wiring line 119. The other terminal of the capacitor 115 is connected to the other terminal of the switch 116. The second connection wiring line 119 is disposed on the lower surface of the detection coil substrate 113, and connected to the external connection connector 112.

Each of the switch 116 and the switch 117 is controlled in an ON or OFF state under control from the detector 120 through a control line which is not illustrated. The ON state is a conduction state while the OFF state is a non-conduction state. The switch 116 has the function of switching the state between the coil 114 and the capacitor 115. When the switch 116 is turned on, the coil 114 and the capacitor 115 form a resonance circuit. The switch 117 has the function of switching the state between the resonance circuit and the pulse generator 130.

In other words, when both the switch 116 and the switch 117 become in the ON state, the coil 114 and the capacitor 115 form the resonance circuit, and pulsing voltage is applied from the pulse generator 130 to the resonance circuit through the first connection wiring line 118 and the second connection wiring line 119. The voltage between both ends of the resonance circuit, that is, the voltage between both ends of the coil 114 is led to the detector 120 through the first connection wiring line 118 and the second connection wiring line 119. When the switch 116 becomes in the OFF state, the coil 114 and the capacitor 115 do not form any resonance circuit. When the switch 117 becomes in the OFF state, the resonance circuit is electrically disconnected from the first connection wiring line 118 and the second connection wiring line 119, and disconnected from the detector 120 and the pulse generator 130.

FIG. 5 is a view illustrating the equivalent circuit of the resonance circuit formed by the coil 114 and the capacitor 115. FIG. 5 illustrates that a foreign substance 10 is present in the vicinity of the resonance circuit. It is assumed that the switch 117 is closed to apply pulsing voltage from the pulse generator 130 in a state in which the switch 116 is closed to allow the coil 114 and the capacitor 115 to form the resonance circuit. In this case, a voltage signal representing the voltage between both ends of the resonance circuit is an oscillating signal of which the peak value is gradually attenuated with passage of time.

The presence of the foreign substance 10 in the vicinity of the coil 114 results in change in the inductance of the coil 114. Therefore, the presence of the foreign substance 10 results in change in the frequency of the oscillating signal or in change in the degree of the attenuation of the oscillating signal, in comparison with the absence of the foreign substance 10. The detector 120 determines the presence or absence of the foreign substance 10 by detecting the change in the frequency of the oscillating signal, the change in the degree of the attenuation of the oscillating signal, or the like.

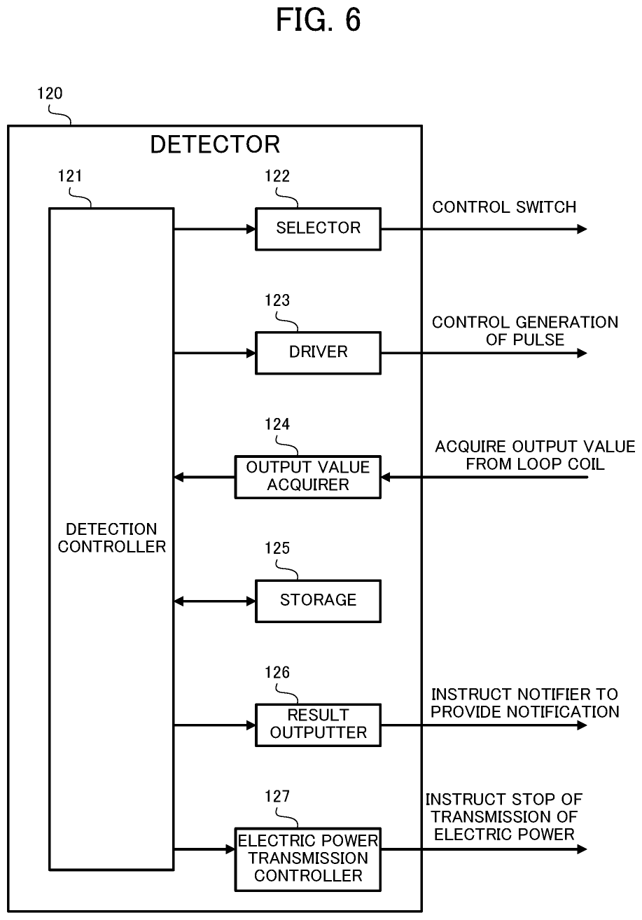

The structure of the detector 120 is illustrated in FIG. 6. The detector 120 is implemented, for example, by a computer including a central processing unit (CPU), a memory, an analog/digital (A/D) converter, and the like, and by an operation program. The detector 120 functionally includes a detection controller 121, a selector 122, a driver 123, an output value acquirer 124, a storage 125, a result outputter 126, and an electric power transmission controller 127.

The detector 120 uses these components, to select any one of the twelve loop coils 111, to allow the switch 116 and switch 117 of the selected loop coil 111 to be in an ON state, to allow the switch 116 and switch 117 of the unselected loop coils 111 to be in an OFF state, and to detect the presence or absence of the foreign substance 10 in the vicinity of the selected loop coil 111. The detector 120 in turn executes detection of the presence or absence of such a foreign substance for all of the twelve loop coils 111, and outputs the results of the detection.

The detection controller 121 controls each component included in the detector 120, and executes the detection of the foreign substance 10, the output of the detection results, and the like. The selector 122 selects any of the twelve loop coils 111 under the control by the detection controller 121, and controls, in an ON state, the switch 116 and the switch 117 included in the selected loop coil 111. After the execution of the selection and the ON-control by the selector 122, the driver 123 drives the pulse generator 130 under the control by the detection controller 121, to singly generate pulsing voltage in the pulse generator 130.

The pulsing voltage is applied to the resonance circuit, formed in the selected loop coil 111, through the external connection connector 112, the first connection wiring line 118, the second connection wiring line 119, and the like. The voltage between both ends of the resonance circuit is led to the output value acquirer 124 through the external connection connector 112, the first connection wiring line 118, the second connection wiring line 119, and the like.

The output value acquirer 124 acquires an output value from the selected loop coil 111 from the oscillating signal representing the voltage between both ends of the resonance circuit under the control by the detection controller 121. The kind of a value at which the output value acquired by the output value acquirer 124 is set can be adjusted as appropriate. For example, the output value can be set at the frequency of the oscillating signal, the convergence time of the oscillating signal, the magnitude of the amplitude of the oscillating signal, or the like. The convergence time of the oscillating signal is, for example, time between the application of the pulsing voltage and the convergence of the amplitude of the oscillating signal to a level that is not more than a predetermined amplitude. The magnitude of the amplitude of the oscillating signal is, for example, the magnitude of the amplitude of the oscillating signal at a lapse of predetermined time after the application of the pulsing voltage.

The storage 125 stores various data on a foreign substance detection process executed by the foreign substance detection device 100. For example, the storage 125 stores an output value, a reference value, a difference value, a threshold value, the number of times of excess, the first number of times, the second number of times, and a first count. Prior to the foreign substance detection process, the reference value, the threshold value, the first number of times, the second number of times, and the first count are stored in the storage 125 in advance. In contrast, the output value, the difference value, and the number of times of excess are updated in the foreign substance detection process.

The output value is an output value acquired by the output value acquirer 124. The reference value is a reference value for the output value. In other words, the reference value is an output value acquired when the foreign substance 10 is absent in the vicinities of the loop coils 111. The reference value has been acquired in advance by an experiment, a simulation, or the like.

The difference value is the value of a difference between the reference value which is an output value acquired when the foreign substance 10 is absent and the currently acquired output value. In other words, the difference value is the amount of change from the output value acquired when the foreign substance 10 is absent. The low difference value means that the foreign substance 10 is highly likely to be absent, while the high difference value means that the foreign substance 10 is highly likely to be present. The threshold value is a threshold value for determining the difference value. The threshold value is set in advance in consideration of, for example, the magnitude of predicted noise, the degree of change in the output value depending on the presence or absence of the foreign substance 10, and the like.

The number of times of excess is the number of times at which the difference value exceeds the threshold value. The number of times of excess is incremented by 1 or reset to 0 whenever the output value is acquired. For example, when the difference value between the acquired output value and the reference value exceeds the threshold value, the number of times of excess is incremented by 1. In contrast, when the difference value between the acquired output value and the reference value does not exceed the threshold value, the number of times of excess is reset to 0.

The first number of times and the second number of times are threshold values for determining the number of times of excess. The presence of the foreign substance 10 is determined when the number of times of excess of any one loop coil 111 of the twelve loop coils 111 reaches the first number of times. In other words, the number of times of excess is the cumulative number of times at which the difference value between the output value from the identical one loop coil 111 among the twelve loop coils 111 and the reference value exceeds the threshold value. The presence of the foreign substance 10 is determined when the number of times of excess of each of loop coils 111, adjacent to each other, of which the number is equal to or more than the first count, among the twelve loop coils 111, reaches the second number of times. The second number of times is less than the first number of times. The second number of times is preferably 2 or more, and the first number of times is preferably 3 or more. The first number of times and the second number of times are set in advance in consideration of, for example, the easiness of occurrence of noise, the magnitude of the risk of the presence of the foreign substance 10, and the like.

In the present embodiment, a case in which two loop coils 111 among loop coils 111 of which the number is N are next to each other in any direction refers to a case in which the two loop coils 111 are adjacent to each other. For example, in FIG. 3, when attention is given to the loop coil 111F, the loop coil 111A is adjacently arranged in an upper left direction, the loop coil 111B is adjacently arranged in an upward direction, the loop coil 111C is adjacently arranged to an upper right direction, the loop coil 111E is adjacently arranged in a lower left direction, the loop coil 111G is adjacently arranged in a lower right direction, and the loop coil 111J is adjacently arranged in a downward direction. Accordingly, the loop coil 111F is adjacent to each of the loop coil 111A, the loop coil 111B, the loop coil 111C, the loop coil 111E, the loop coil 111G, and the loop coil 111J.

Three or more loop coils 111 are considered to be adjacent to each other as long as being adjacent as a whole. For example, in FIG. 3, three loop coils 111 which are the loop coil 111A, the loop coil 111B, and the loop coil 111C are adjacent as a whole, and are therefore considered to be adjacent to each other. This is because the loop coil 111A and the loop coil 111B are adjacent to each other, and the loop coil 111B and the loop coil 111C are adjacent to each other although the loop coil 111A and the loop coil 111C are not adjacent to each other.

The first count is a count of a plurality of loop coils 111 adjacent to each other, needed in the detection of the foreign substance using the second number of times. An optional count of more than one, that is, an optional count of two or more can be adopted as the first count. The first count is set in advance depending on, for example, the size of the foreign substance 10 to be immediately detected. For example, when the size of the foreign substance 10 to be immediately detected is such a size that the foreign substance 10 overlaps two or more loop coils 111 in planar view, the first count is set to two.

In other words, in the present embodiment, a foreign substance 10 which is so large as to overlap two or more loop coils 111 in planar view is immediately detected, while time is spent to accurately detect a foreign substance 10 which is so small as to overlap one loop coil 111 in planar view. The large foreign substance 10 is considered to greatly influence transmission of electric power and to result in the large amount of generated heat, and is therefore desired to be immediately detected. In contrast, the small foreign substance 10 is considered to less influence transmission of electric power and to result in the small amount of generated heat, and it is therefore considered that the small foreign substance 10 need not be immediately detected. Conceivable examples of the large foreign substance 10 include a tobacco box including paper and aluminum foil. Conceivable examples of the small foreign substance 10 include coins such as a 10-yen coin and a 100-yen coin.

In the present embodiment, the reference value, the threshold value, the first number of times, the second number of times, and the first count are shared in the twelve loop coils 111, and only one thereof is prepared. In contrast, such output values, difference values, and numbers of times of excess are prepared for the twelve loop coils 111, respectively.

The detection controller 121 repeatedly executes a consecutive comparison process. The consecutive comparison process is a process of executing individual comparison processes of the twelve loop coils 111 in predetermined order. Such an individual comparison process is a process in which a value for comparison based on an output value and the threshold value are compared for one loop coil 111. The value for comparison, which is a value for comparison with the threshold values, is specifically the difference value between the output value and the reference value, or a value based on the difference value. In the present embodiment, the value for comparison is the difference value between the output value and the reference value. The detection controller 121 determines the presence or absence of the foreign substance 10 on the basis of the comparison results of the individual comparison processes.

The consecutive comparison process is a process of executing the individual comparison processes in execution order (hereinafter referred to, as appropriate, as “initial execution order”) of, for example, the loop coil 111A, the loop coil 111B, the loop coil 111C, the loop coil 111D, the loop coil 111E, the loop coil 111F, the loop coil 111G, the loop coil 111H, the loop coil 111I, the loop coil 111J, the loop coil 111K, and the loop coil 111L. In other words, the detection controller 121 executes the individual comparison processes in order of the loop coil 111A, the loop coil 111B, . . . , the loop coil 111L, the loop coil 111A, the loop coil 111B, . . . .

The detection controller 121 determines that the foreign substance 10 is present when the number of times of excess in an excess sensor reaches the first number of times in a case in which the excess sensor is present in one consecutive comparison process. The excess sensor is a sensor in which the difference value exceeds the threshold value. In the present embodiment, the sensor is a loop coil 111, and therefore, the excess sensor is a loop coil 111 in which the difference value exceeds the threshold value.

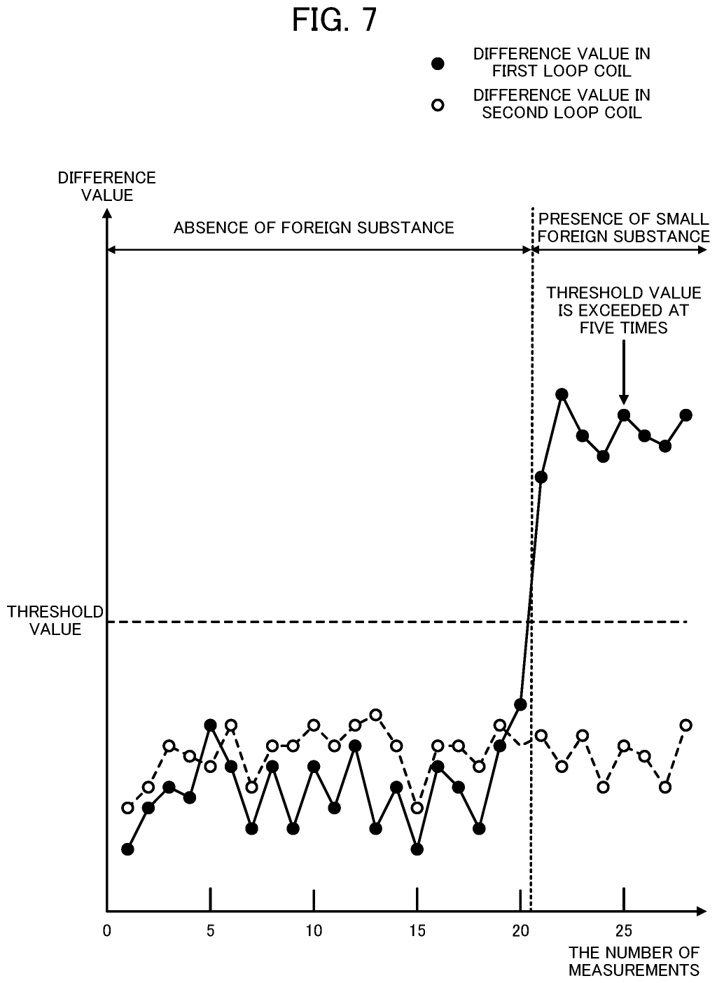

An example in which the number of times of excess at which the difference value in one sensor exceeds the threshold value reaches the first number of times, whereby the presence of the foreign substance 10 is determined, will be described below with reference to FIG. 7. A first graph indicating a correspondence relationship between the number of measurements and the difference value is illustrated in FIG. 7. In FIG. 7, difference values in the first loop coil are denoted by black circles, and difference values in the second loop coil are denoted by white circles. The first loop coil is any one loop coil 111 of the twelve loop coils 111. The second loop coil is any one loop coil 111, adjacent to the first loop coil, of the twelve loop coils 111. In such a case, the first number of times is 5.

The first graph represents that in the first loop coil, difference values between the first measurement and the 20th measurement do not exceed the threshold value but difference values at the 21st and later measurements exceed the threshold value. Moreover, the first graph represents that difference values in the first measurement and later in the second loop coil do not continuously exceed the threshold value. In the first loop coil, the number of times of excess reaches the first number of times at the time of the completion of the 25th measurement. Accordingly, the detection controller 121 determines the presence of the foreign substance 10 at the time of the completion of the 25th measurement.

A case in which only the difference value in the first loop coil exceeds the threshold value means that the small foreign substance 10 is highly likely to be present in the vicinity of the first loop coil. The small foreign substance 10 is, for example, a foreign substance 10 that has a size similar to or smaller than the size of one loop coil 111 in planar view and that influences only the output value from one loop coil 111. As described above, the first graph represents that the small foreign substance 10 is arranged in the vicinity of the first loop coil just after the completion of the 20th measurement.

The detection controller 121 determines that the foreign substance 10 is present when the number of times of excess in each of excess sensors of which the number is the first count reaches the second number of times which is less than the first number of times in the presence of the excess sensors of which the number is the first count that is more than one in one consecutive comparison process.

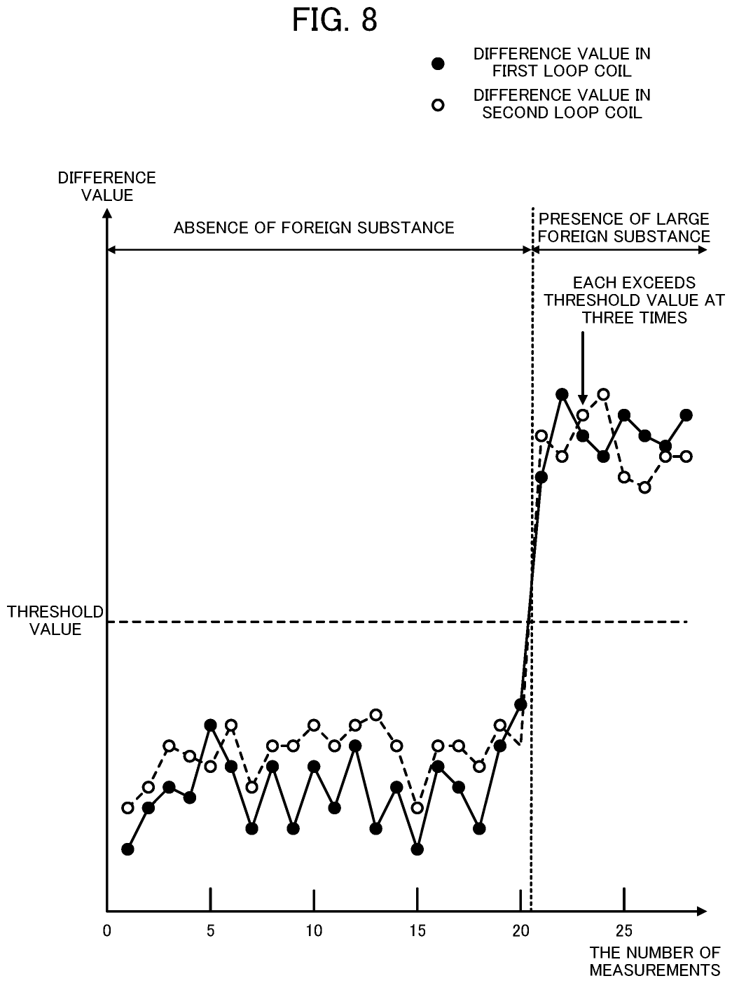

An example in which the number of times of excess at which the difference value in each of the sensors of which the number is the first count exceeds the threshold value reaches the second number of times, whereby the presence of the foreign substance 10 is determined, will be described below with reference to FIG. 8. A second graph indicating a correspondence relationship between the number of measurements and the difference value is illustrated in FIG. 8. In FIG. 8, difference values in the first loop coil are denoted by black circles, and difference values in the second loop coil are denoted by white circles. In such a case, the second number of times is 3, and the first count is two.

The second graph represents that in both the first loop coil and the second loop coil, difference values between the first measurement and the 20th measurement do not exceed the threshold value but difference values at the 21st and later measurements exceed the threshold value. In both the first loop coil and the second loop coil, the number of times of excess reaches the second number of times at the time of the completion of the 23th measurement. Accordingly, the detection controller 121 determines the presence of the foreign substance 10 at the time of the completion of the 23th measurement.

A case in which both the difference value in the first loop coil and the difference value in the second loop coil exceed the threshold value means that the foreign substance 10 is highly likely to be present in the vicinities of the first loop coil and the second loop coil, typically, that the large foreign substance 10 is present astride the first loop coil and the second loop coil. The large foreign substance 10 is, for example, a foreign substance 10 that has a size similar to or larger than the size of two loop coils 111 in planar view and that influences the output values from two or more loop coils 111.

A case in which the difference value in one loop coil 111 exceeds the threshold value means that the small foreign substance 10 is highly likely to be present. A case in which the difference values in loop coils 111 of which the number is equal to or more than the first count exceed the threshold value means that the large foreign substance 10 is highly likely to be present. It is considered that the large foreign substance 10 is highly likely to greatly influence transmission of electric power, and to result in great influence in the case of generating heat. In other words, it is considered that it is desired to more immediately complete the detection and notification of the foreign substance 10 in a case in which the difference values in the loop coils 111 of which the number is equal to or more than the first count exceed the threshold value than in a case in which only one loop coil 111 exceeds the threshold value. Thus, the second number of times is set at the number of times that is less than the first number of times.

The result outputter 126 outputs the detection results from the detection controller 121 under the control by the detection controller 121. For example, when the presence of the foreign substance 10 is determined by the detection controller 121, the result outputter 126 instructs the notifier 140 to provide notification that the foreign substance 10 is present. The notifier 140 transmits information, representing the detection of the foreign substance, to the terminal device 600 possessed by the user when receiving the notification from the detection controller 121. The terminal device 600 notifies the user of the detection of the foreign substance through screen display, voice output, or the like.

The electric power transmission controller 127 controls transmission of electric power to the electric power reception coil unit 310 by the electric power transmission coil unit 210 under the control by the detection controller 121. When the detection controller 121 determines the presence of the foreign substance 10, the electric power transmission controller 127 instructs the power supply 220 to stop the transmission of the electric power.

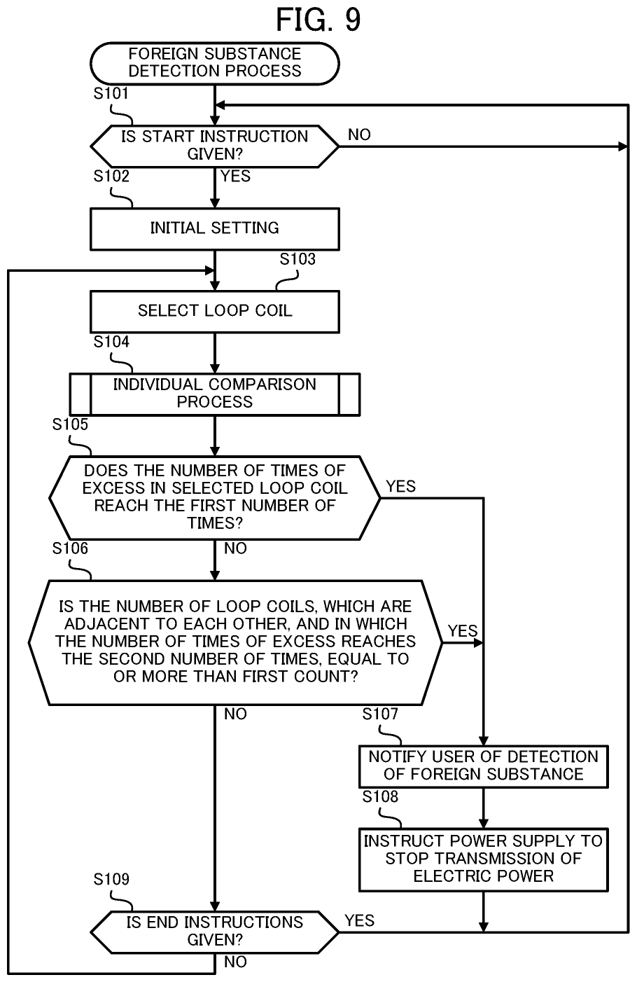

The foreign substance detection process executed by the foreign substance detection device 100 will now be described with reference to FIG. 9. The foreign substance detection process is started, for example, at power-up of the foreign substance detection device 100.

First, the detector 120 included in the foreign substance detection device 100 determines whether or not an instruction to start the foreign substance detection process is given (step S101). For example, the detector 120 determines that the instruction to start the foreign substance detection process is given when the foreign substance detection device 100 is notified of the start of the transmission of the electric power from the power supply 220. When determining that the instruction to start the foreign substance detection process is given (step S101: YES), the detector 120 executes an initial setting (step S102). The initial setting is an initial setting for the foreign substance detection process. In the initial setting, for example, the switch 116 and the switch 117 included in the detection coil unit 110 are set in an OFF state, and the number of times of excess is reset to 0.

When completing the process of step S102, the detector 120 selects the loop coil 111 (step S103). For example, the detector 120 selects one loop coil 111 from the twelve loop coils 111 in predetermined initial execution order. Specifically, the detector 120 selects the loop coils 111 in order of the loop coil 111A, the loop coil 111B, the loop coil 111C, . . . , the loop coil 111L, the loop coil 111A, the loop coil 111B . . . .

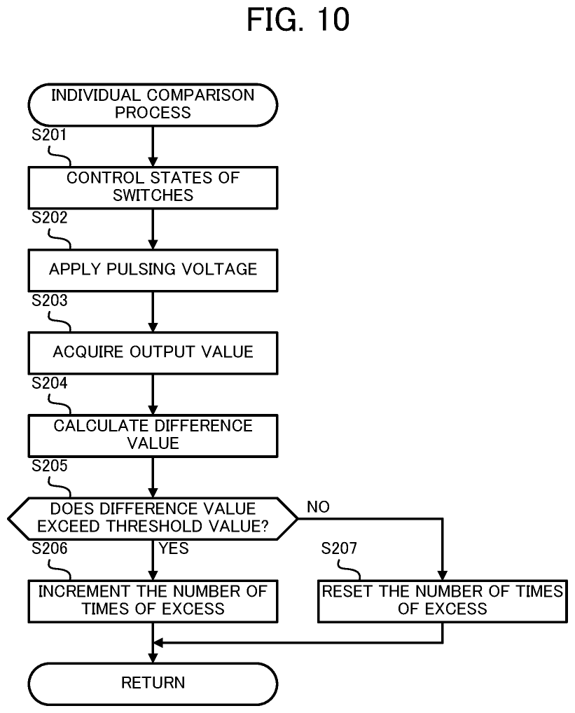

When completing the process of step S103, the detector 120 executes an individual comparison process of the selected loop coil 111 (step S104). The individual comparison process will be described in detail with reference to FIG. 10. In the foreign substance detection process, waiting time may be set as appropriate so that an individual comparison process is executed at a constant interval, or waiting time may be prevented from being set so as to execute as many individual comparison processes as possible.

First, the detector 120 controls the states of the switch 116 and the switch 117 (step S201). In other words, the detector 120 controls the switch 116 and the switch 117, included in the selected loop coil 111, in ON states, and controls the switches 116 and the switches 117, included in the unselected loop coils 111, in OFF states. When completing the process of step S201, the detector 120 applies pulsing voltage to the selected loop coil 111 (step S202). In other words, the detector 120 controls the pulse generator 130 to generate the pulsing voltage.

When completing the process of step S202, the detector 120 acquires an output value from the selected loop coil 111 (step S203). When completing the process of step S203, the detector 120 calculates a difference value from the acquired output value and the reference value (step S204). When completing the process of step S204, the detector 120 determines whether or not the difference value exceeds the threshold value (step S205).

When determining that the difference value exceeds the threshold value (step S205: YES), the detector 120 increments the number of times of excess (step S206). In other words, the detector 120 increments the number of times of excess by 1. When determining that the difference value does not exceed the threshold value (step S205: NO), the detector 120 resets the number of times of excess (step S207). In other words, the detector 120 sets the number of times of excess to 0. When completing the process of step S206 or step S207, the detector 120 completes the individual comparison process.

When completing the individual comparison process of step S104, the detector 120 determines whether or not the number of times of excess in the selected loop coil 111 reaches the first number of times (step S105). When determining that the number of times of excess in the selected loop coil 111 does not reach the first number of times (step S105: NO), the detector 120 determines whether or not the number of present loop coils 111, which are adjacent to each other, and in which the number of times of excess reaches the second number of times, is equal to or more than the first count (step S106). The process of determining whether or not the number of present loop coils 111, which are adjacent to each other, and in which the number of times of excess reaches the second number of times, is equal to or more than the first count (process of step S106) may be carried out before the process of determining whether or not the number of times of excess in the selected loop coil 111 reaches the first number of times (process of step S105).

When it is determined that the number of times of excess in the selected loop coil 111 reaches the first number of times (step S105: YES), or it is determined that the number of present loop coils 111, which are adjacent to each other, and in which the number of times of excess reaches the second number of times, is equal to or more than the first count (step S106: YES), the user is notified of the detection of the foreign substance (step S107).

For example, the detector 120 instructs the notifier 140 to provide notification. The notifier 140 transmits information, representing the detection of the foreign substance 10, to the terminal device 600 according to the instruction by the detector 120. When receiving the information, the terminal device 600 notifies the user of the detection of the foreign substance 10 through screen display, voice output, or the like. When receiving the notification of the presence of the foreign substance 10 from the terminal device 600, the user removes the foreign substance 10.

When completing the process of step S107, the detector 120 instructs the power supply 220 to stop the transmission of the electric power (step S108). For example, the detector 120 transmits information for instructing the power supply 220 to stop the transmission of the electric power. When receiving the information, the power supply 220 stops the transmission of the electric power. When determining that the number of present loop coils 111, which are adjacent to each other, and in which the number of times of excess reaches the second number of times, is not equal to or not more than the first count (step S106: NO), the detector 120 determines whether or not an instruction to end the foreign substance detection process is given (step S109). The process of instructing the power supply 220 to stop the transmission of the electric power (process of step S108) may also be carried out before the process of notifying the user of the detection of the foreign substance (process of step S107).

For example, when the foreign substance detection device 100 is notified of the end of the transmission of the electric power from the power supply 220, the detector 120 determines that the instruction to end the foreign substance detection process is given. When determining that the instruction to end the foreign substance detection process is not given (step S109: NO), the detector 120 returns the process to step S103. When determining that the instruction to start the foreign substance detection process is not given (step S101: NO), completing the process of step S108, or determining that the instruction to end the foreign substance detection process is given (step S109: YES), the detector 120 returns the process to step S101.

In the present embodiment, the presence of the foreign substance 10 is determined in cases in which the number of times of excess in one excess sensor reaches the first number of times, and the number of times of excess in each of the excess sensors of which the number is the first count that is more than one reaches the second number of times which is less than the first number of times. Accordingly, in accordance with the present embodiment, a speed at which the relatively large foreign substance 10 is detected can be improved while suppressing false detection.

In other words, the presence of the foreign substance 10 is determined in a case in which a state in which the output value from one sensor differs from the reference value continues for relatively long time. In this case, false detection is considered to less frequently occur because the output value is monitored for long time. Accordingly, the small foreign substance 10 considered not to so much adversely affect transmission of electric power and not to result in the so large amount of generated heat is accurately detected.

The presence of the foreign substance 10 is determined when a state in which output values from sensors of which the number is the first count that is more than one (typically, sensors of which the number is the first count that is more than one, and which are adjacent to each other) differ from the reference value continues even in a relatively short time. Accordingly, the large foreign substance 10 considered to much adversely affect transmission of electric power and to result in the large amount of generated heat is immediately detected. In this case, false detection is considered to less frequently occur because the second number of times is 2 or more.

### Embodiment 2

Embodiment 1 describes the example in which the threshold value of the number of times of excess is set in two stages depending on the count of the excess sensors. Embodiment 2 describes an example in which the threshold value of the number of times of excess is set in three stages depending on the count of the excess sensors. Description of structures and processes similar to those in Embodiment 1 will be omitted or simplified.

In the present embodiment, a detector 120 determines that a foreign substance 10 is present when the number of times of excess in each of excess sensors of which the number is a second count reaches the third number of times which is less than the second number of times in a case in which the excess sensors of which the number is the second count that is more than the first count are present in one consecutive comparison process. The second count and the third number of times are stored in advance in a storage 125 prior to the foreign substance detection process described below.

The second count is a count of a plurality of loop coils 111 adjacent to each other, needed in the detection of the foreign substance using the third number of times. An optional count of more than the first count can be adopted as the second count. The second count is set in advance depending on, for example, the size of the foreign substance to be immediately detected. For example, when it is necessary to extremely immediately detect the foreign substance 10 having such a size that the foreign substance 10 overlaps three or more loop coils 111 in planar view, the second count is set to three.

The third number of times is a threshold values for determining the number of times of excess. The presence of the foreign substance 10 is determined when the number of times of excess of each of loop coils 111, adjacent to each other, of which the number is equal to or more than the second count, among the twelve loop coils 111, reaches the third number of times. The third number of times is set in advance in consideration of, for example, the easiness of occurrence of noise, the magnitude of the risk of the presence of the foreign substance 10, and the like. In the present embodiment, the first count is two, the second count is three, the first number of times is 5, the second number of times is 3, and the third number of times is 2.

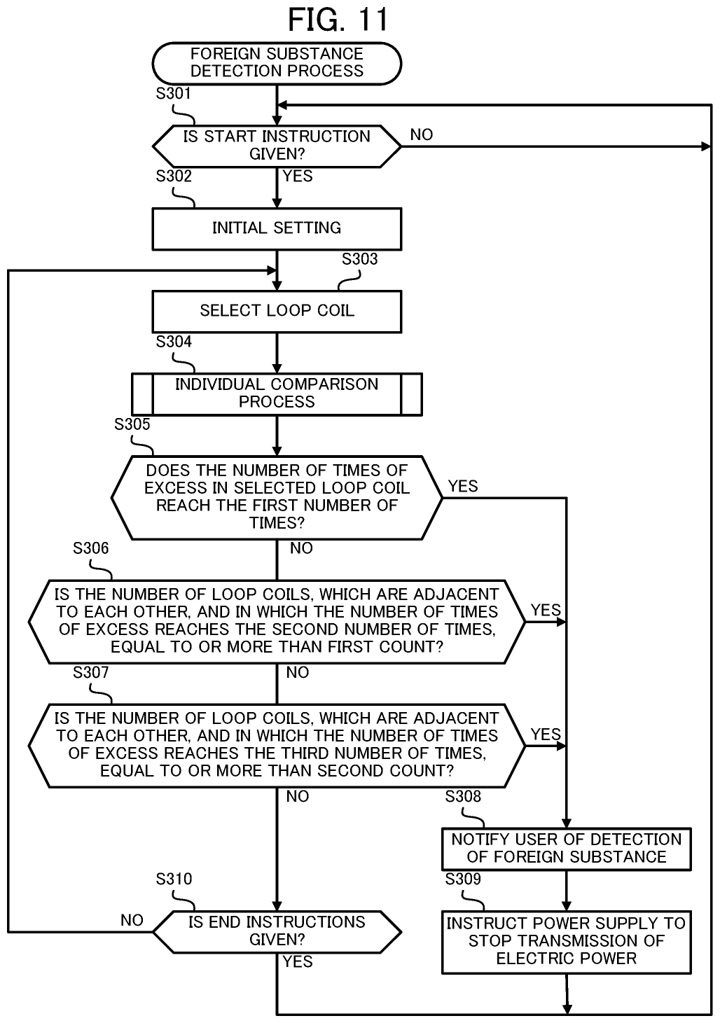

A foreign substance detection process executed by a foreign substance detection device 100 according to the present embodiment will be described with reference to FIG. 11

First, the detector 120 determines whether or not an instruction to start the foreign substance detection process is given (step S301). When determining that the instruction to start the foreign substance detection process is given (step S301: YES), the detector 120 executes an initial setting (step S302). When completing the process of step S302, the detector 120 selects a loop coil 111 (step S303). When completing the process of step S303, the detector 120 executes an individual comparison process for the selected loop coil 111 (step S304).

When completing the individual comparison process of step S304, the detector 120 determines whether or not the number of times of excess in the selected loop coil 111 reaches the first number of times (step S305). When determining that the number of times of excess in the selected loop coil 111 does not reach the first number of times (step S305: NO), the detector 120 determines whether or not the number of present loop coils 111, which are adjacent to each other, and in which the number of times of excess reaches the second number of times, is equal to or more than the first count (step S306).

When determining the number of the present loop coils 111, which are adjacent to each other, and in which the number of times of excess reaches the second number of times, is not equal to or not more than the first count (step S306: NO), the detector 120 determines whether or not the number of present loop coils 111, which are adjacent to each other, and in which the number of times of excess reaches the third number of times, is equal to or more than the second count (step S307). In other words, the detector 120 determines whether or not the number of times of excess in each of the loop coils 111, which are adjacent to each other, and of which the number is equal to or more than the second count, reaches the third number of times. The process of determining whether or not the number of the present loop coils 111, which are adjacent to each other, and in which the number of times of excess reaches the third number of times, is equal to or more than the second count (process of step S307), the process of determining whether or not the number of the present loop coils 111, which are adjacent to each other, and in which the number of times of excess reaches the second number of times, is equal to or more than the first count (process of step S306), and the process of determining whether or not the number of times of excess in the selected loop coil 111 reaches the first number of times (process of step S305) may also be carried out in the order mentioned above.

When determining that the number of times of excess in the selected loop coil 111 reaches the first number of times (step S305: YES), determining that the number of the present loop coils 111, which are adjacent to each other, and in which the number of times of excess reaches the second number of times, is equal to or more than the first count (step S306: YES), or determining that the number of the present loop coils 111, which are adjacent to each other, and in which the number of times of excess reaches the second number of times, is equal to or more than the first count (step S307: YES), the detector 120 notifies a user of the detection of the foreign substance (step S308). When completing the process of step S308, the detector 120 instructs a power supply 220 to stop transmission of electric power (step S309). The process of instructing the power supply 220 to stop the transmission of the electric power (process of step S309) may also be carried out before the process of notifying the user of the detection of the foreign substance (process of step S308).

When determining the number of the present loop coils 111, which are adjacent to each other, and in which the number of times of excess reaches the third number of times, is not equal to or not more than the second count (step S307: NO), the detector 120 determines whether or not an instruction to end the foreign substance detection process is given (step S310). When determining that the instruction to end the foreign substance detection process is not given (step S310: NO), the detector 120 returns the process to step S303. When determining that the instruction to start the foreign substance detection process is not given (step S301: NO), completing the process of step S309, or determining that the instruction to end the foreign substance detection process is given (step S310: YES), the detector 120 returns the process to step S301.

In the present embodiment, the threshold value of the number of times of excess is set in the three stages depending on the count of the excess sensors, and the larger count of the excess sensors results in the setting of the lower threshold value of the number of times of excess. Accordingly, a speed at which the relatively large foreign substance 10 is detected can be improved, and a speed at which the extremely large foreign substance 10 is detected can be further improved, while suppressing false detection, in accordance with the present embodiment.

### Embodiment 3

Embodiments 1 and 2 describe the examples in which the individual comparison processes are executed in unchanged order even when the excess sensors of which the number is the first count are detected in the execution of one consecutive comparison process. Embodiment 3 describes an example in which individual comparison processes are executed in changed order when excess sensors of which the number is a first count are detected in the execution of one consecutive comparison process. Description of structures and processes similar to those in Embodiments 1 and 2 will be omitted or simplified.

In the present embodiment, when excess sensors of which the number is the first count are detected in the execution of one consecutive comparison process, a detector 120 consecutively executes individual comparison processes for each of the detected excess sensors of which the number is the first count, at the predetermined number of times.

For example, when consecutive comparison processes of execution in initial execution order of a loop coil 111A, a loop coil 111B, . . . , and a loop coil 111L are repeatedly executed, a case is considered in which the difference value in the loop coil 111C and the difference value in the loop coil 111D adjacent to the loop coil 111C exceed a threshold value in the N-th consecutive comparison process. In this case, the individual comparison process for the loop coil 111D in the N-th consecutive comparison process is executed, followed by consecutively executing the individual comparison process for the loop coil 111C and the individual comparison process for the loop coil 111D.

In other words, the individual comparison processes are executed in order of the loop coil 111A, the loop coil 111B, the loop coil 111C, the loop coil 111D, the loop coil 111C, the loop coil 111D, the loop coil 111C, the loop coil 111D, . . . , from the beginning of the N-th consecutive comparison process. The specified number of times at which the individual comparison processes consecutively executed can be adjusted as appropriate. For example, the specified number of times at which the individual comparison processes, including the individual comparison process in which the difference value first exceeds the threshold value, are executed is preferably 2 or more.

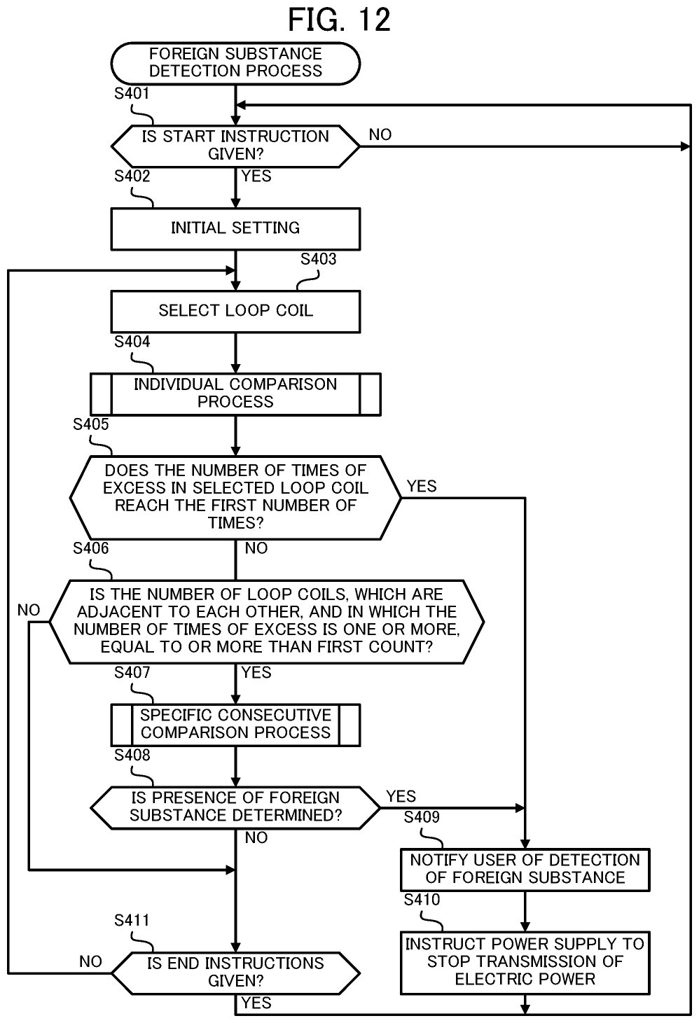

A foreign substance detection process executed by a foreign substance detection device 100 according to the present embodiment will now be described with reference to FIG. 12.

First, the detector 120 determines whether or not an instruction to start the foreign substance detection process is given (step S401). When determining that the instruction to start the foreign substance detection process is given (step S401: YES), the detector 120 executes an initial setting (step S402). When completing the process of step S402, the detector 120 selects a loop coil 111 (step S403). When completing the process of step S403, the detector 120 executes an individual comparison process (step S404).

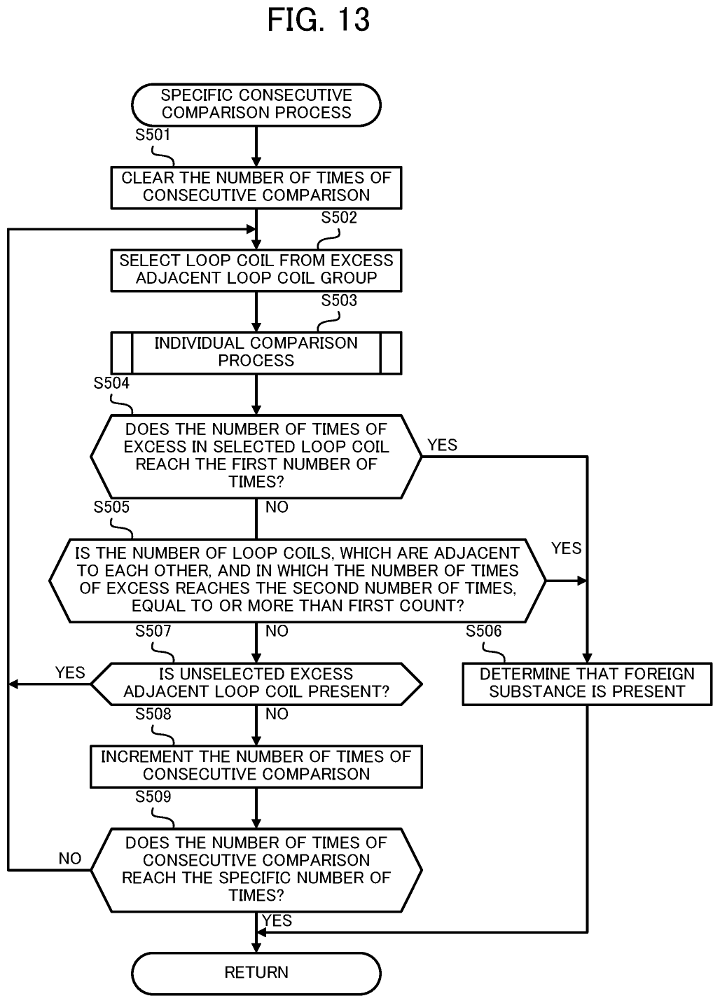

When completing the process of step S404, the detector 120 determines whether or not the number of times of excess in the selected loop coil 111 reaches the first number of times (step S405). When determining that the number of times of excess in the selected loop coil 111 does not reach the first number of times (step S405: NO), the detector 120 determines whether or not the number of present loop coils 111 which are adjacent to each other, and in which the number of times of excess is 1 or more is equal to or more than the first count (step S406). When determining that the number of the present loop coils 111 which are adjacent to each other, and in which the number of times of excess is 1 or more is equal to or more than the first count (step S406: YES), the detector 120 executes a specific consecutive comparison process (step S407). The specific consecutive comparison process will be described in detail with reference to FIG. 13. The process of determining whether or not the number of the present loop coils 111 which are adjacent to each other, and in which the number of times of excess is 1 or more is equal to or more than the first count (process of step S406) may also be carried out before the process of determining whether or not the number of times of excess in the selected loop coil 111 reaches the first number of times (process of step S405).

First, the detector 120 clears the number of times of consecutive comparison (step S501). For example, the detector 120 sets the number of times of consecutive comparison, stored in a storage 125, to 0. When completing the process of step S501, the detector 120 selects a loop coil 111 from an excess adjacent loop coil group (step S502). The excess adjacent loop coil group includes loop coils 111 in which the difference values exceed the threshold value, which are adjacent to each other, and of which the number is equal to or more than the first count. For example, the detector 120 selects a loop coil 111 from the excess adjacent loop coil group in descending order of initial execution. The detector 120 may select a loop coil 111 from the excess adjacent loop coil group in relatively deceasing order of the difference value between an output value which is a value for comparison and a reference value.

When completing the process of step S502, the detector 120 executes an individual comparison process for the selected loop coil 111 (step S503). When completing the process of step S503, the detector 120 determines whether or not the number of times of excess in the selected loop coil 111 reaches the first number of times (step S504). When determining that the number of times of excess in the selected loop coil 111 does not reach the first number of times (step S504: NO), the detector 120 determines whether or not the number of present loop coils 111, which are adjacent to each other, and in which the number of times of excess reaches the second number of times, is equal to or more than the first count (step S505). The process of determining whether or not the number of the present loop coils 111, which are adjacent to each other, and in which the number of times of excess reaches the second number of times, is equal to or more than the first count (process of step S505) may also be carried out before the process of determining whether or not the number of times of excess in the selected loop coil 111 reaches the first number of times (process of step S504).

When determining that the number of times of excess in the selected loop coil 111 reaches the first number of times (step S504: YES), or determining that the number of the present loop coils 111, which are adjacent to each other, and in which the number of times of excess reaches the second number of times, is equal to or more than the first count (step S505: YES), the detector 120 determines that a foreign substance 10 is present (step S506). When determining that the number of the present loop coils 111, which are adjacent to each other, and in which the number of times of excess reaches the second number of times, is not equal to or not more than the first count (step S505: NO), the detector 120 determines whether or not an unselected excess adjacent loop coil is present (step S507).

When determining that the unselected excess adjacent loop coil is absent (step S507: NO), the detector 120 increments the number of times of consecutive comparison (step S508). In other words, the detector 120 increments the number of times of consecutive comparison, stored in a storage 250, by 1. When completing the process of step S508, the detector 120 determines whether or not the number of times of consecutive comparison reaches the specified number of times (step S509).

When determining that the unselected excess adjacent loop coil is present (step S507: YES), or determining that the number of times of consecutive comparison does not reach the specified number of times (step S509: NO), the detector 120 returns the process to step S502. When completing the process of step S506, or determining that the number of times of consecutive comparison reaches the specified number of times (step S509: YES), the detector 120 completes the specific consecutive comparison process.

When completing the specific consecutive comparison process of step S407, the detector 120 determines whether or not the presence of the foreign substance 10 is determined in the specific consecutive comparison process (step S408). When determining that the number of times of excess in the selected loop coil 111 reaches the first number of times (step S405: YES), or determining that the presence of the foreign substance 10 is determined (step S408: YES), the detector 120 notifies a user of the detection of the foreign substance (step S409). When completing the process of step S409, the detector 120 instructs a power supply 220 to stop transmission of electric power (step S410). The process of instructing the power supply 220 to stop the transmission of the electric power (process of step S410) may also be carried out before the process of notifying the user of the detection of the foreign substance (process of step S409).

When determining that the number of the present loop coils 111, which are adjacent to each other, and in which the number of times of excess is 1 or more, is not equal to or not more than the first count (step S406: NO), or determining that the absence of the foreign substance 10 is determined (step S408: NO), the detector 120 determines whether or not an instruction to end the foreign substance detection process is given (step S411). When determining that the instruction to end the foreign substance detection process is not given (step S411: NO), the detector 120 returns the process is to step S403. When determining that the start instruction is not given (step S401: NO), completing the process of step S410, or determining that the instruction to end the foreign substance detection process is given (step S411: YES), the detector 120 returns the process to step S401.

In the present embodiment, when excess sensors of which the number is the first count are detected in the execution of one consecutive comparison process, individual comparison processes for each of the detected excess sensors of which the number is the first count are consecutively executed at the predetermined number of times. Accordingly, the large foreign substance 10 can be immediately detected in accordance with the present embodiment.

### Embodiment 4

Embodiment 3 describes the example in which when the excess sensors of which the number is equal to or more than the first count are detected in the execution of one consecutive comparison process, the individual comparison processes for the detected excess sensors of which the number is equal to or more than the first count are consecutively executed. Embodiment 4 describes an example in which when excess sensors of which the number is equal to or more than a first count are detected in execution of one consecutive comparison process, the subsequent consecutive comparison processes are executed such that an individual comparison process for each of the excess sensors, which are detected in the consecutive comparison process, and of which the number is equal to or more than the first count, is executed in earlier order. Description of structures and processes similar to those in Embodiments 1 to 3 will be omitted or simplified.

For example, when consecutive comparison processes of execution in initial execution order of a loop coil 111A, a loop coil 111B, . . . , and a loop coil 111L are repeatedly executed, a case is considered in which the difference value in the loop coil 111C and the difference value in the loop coil 111D adjacent to the loop coil 111C exceed a threshold value in the N-th consecutive comparison process. In this case, the order in which the individual comparison processes are executed in the consecutive comparison processes is changed so that the individual comparison process for the loop coil 111C and the individual comparison process for the loop coil 111D are executed in the earliest order. Thus, the (N+1)th and later consecutive comparison processes are repeatedly executed.

In other words, the individual comparison processes are executed in order of the loop coil 111A, the loop coil 111B, the loop coil 111C, the loop coil 111D, the loop coil 111E, . . . , the loop coil 111L, the loop coil 111C, the loop coil 111D, the loop coil 111A, the loop coil 111B, the loop coil 111E, . . . , the loop coil 111L, the loop coil 111C, the loop coil 111D, the loop coil 111A, the loop coil 111B, the loop coil 111E, . . . , the loop coil 111L, from the beginning of the N-th consecutive comparison process.

Timing until which the changed order of the execution is maintained can be adjusted as appropriate. For example, the changed order of the execution may be maintained until the consecutive comparison processes are executed at the specified number of times after the change of the order of the execution. Alternatively, the changed order of the execution may be maintained until excess sensors of which the number is equal to or more than the first count are newly detected.

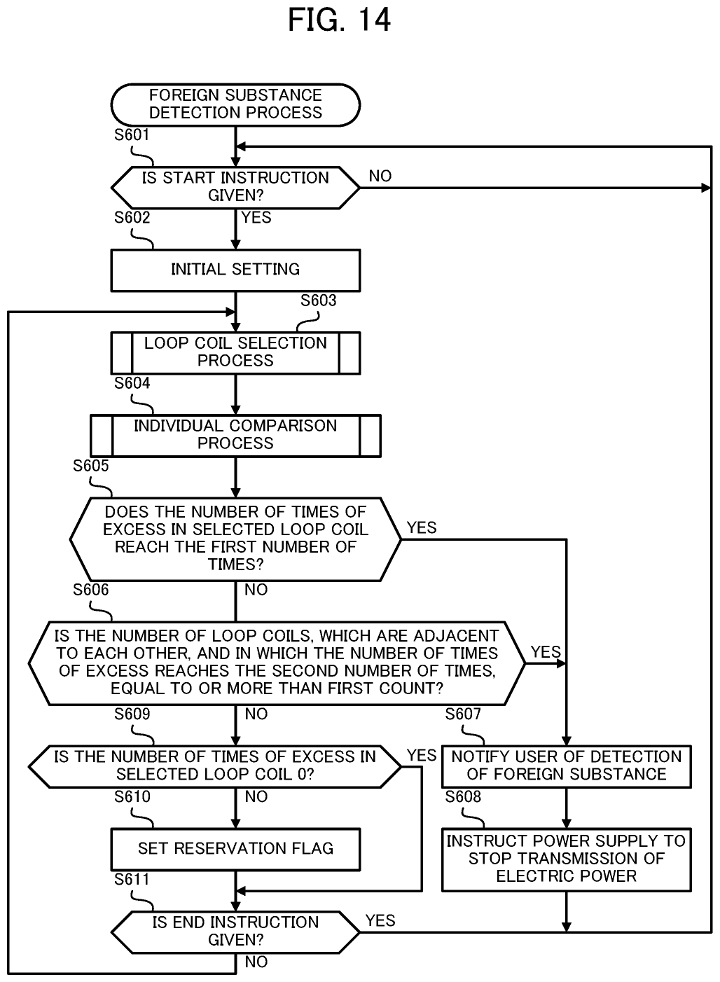

A foreign substance detection process executed by a foreign substance detection device 100 according to the present embodiment will now be described with reference to FIG. 14.

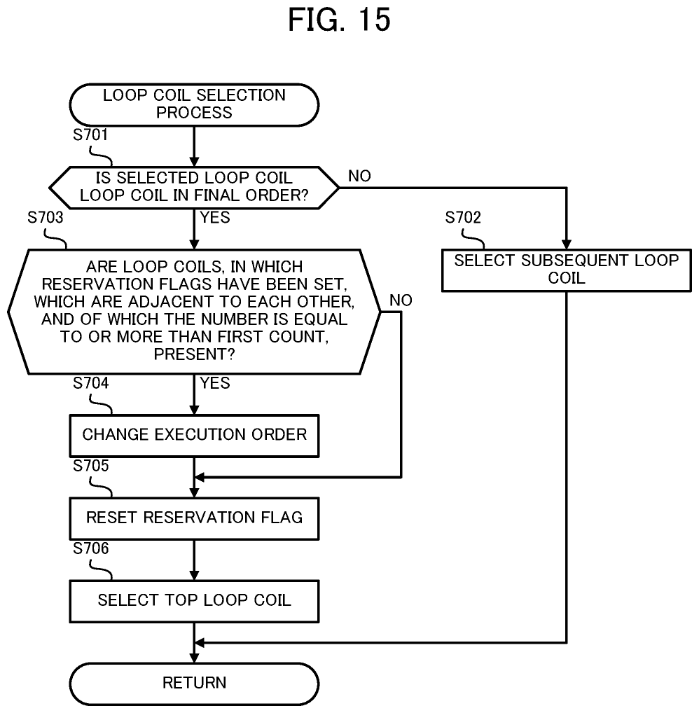

First, the detector 120 determines whether or not an instruction to start the foreign substance detection process is given (step S601). When determining that the instruction to start the foreign substance detection process is given (step S601: YES), the detector 120 executes an initial setting (step S602). When completing the process of step S602, the detector 120 executes a loop coil selection process (step S603). The loop coil selection process will be described in detail with reference to FIG. 15.

First, the detector 120 determines whether or not the selected loop coil 111 is a loop coil 111 in the final order (step S701). The loop coil 111 in the final order is a loop coil 111 in which an individual comparison process is finally executed in current execution order. When the current execution order is initial execution order, the loop coil 111 in the final order is the loop coil 111L. When determining that the selected loop coil 111 is not the loop coil 111 in the final order (step S701: NO), the detector 120 selects the subsequent loop coil 111 (step S702).

When determining that the selected loop coil 111 is the loop coil 111 in the final order (step S701: YES), the detector 120 determines whether or not loop coils 111, in which reservation flags have been set, which are adjacent to each other, and of which the number is equal to or more than the first count, are present (step S703). The reservation flags are flags for making a reservation for changing execution order, and is prepared for each of the loop coils 111. The reservation flags for the selected loop coils 111 are set when the number of times of excess in the selected loop coil 111 is not 0 in the consecutive comparison processes, as described below. In other words, the detector 120 determines whether or not the number of the present loop coils 111, in which the number of times of excess is not 0 in the previously executed consecutive comparison process, and which are adjacent to each other, is equal to or more than the first count.

When determining that the loop coils 111, in which the reservation flags have been set, which are adjacent to each other, and of which the number is equal to or more than the first count, are present (step S703: YES), the detector 120 changes the execution order (step S704). For example, the detector 120 changes the execution order so that loop coils 111, in which reservation flags have been set, and of which the number is equal to or more than the first count, are first executed. For example, when reservation flags have been set in the loop coil 111C and the loop coil 111D, the execution order is changed to order of the loop coil 111C, the loop coil 111D, the loop coil 111A, the loop coil 111B, the loop coil 111E, . . . , and the loop coil 111L.

When determining that the loop coils 111, in which the reservation flags have been set, which are adjacent to each other, and of which the number is equal to or more than the first count, are absent (step S703: NO), or completing the process of step S704, the detector 120 resets the reservation flags (step S705). The detector 120 resets the reservation flags for all the loop coils 111. When completing the process of step S705, the detector 120 selects the top loop coil 111 in the current execution order (step S706). When completing the process of step S702 or step S706, the detector 120 completes the loop coil selection process.

When completing the loop coil selection process of step S603, the detector 120 executes individual comparison processes (step S604). When completing the individual comparison processes of step S604, the detector 120 determines whether or not the number of times of excess in the selected loop coil 111 reaches the first number of times (step S605). When determining that the number of times of excess in the selected loop coil 111 does not reach the first number of times (step S605: NO), the detector 120 determines whether or not the number of present loop coils 111, which are adjacent to each other, and in which the number of times of excess reaches the second number of times, is equal to or more than the first count (step S606). The process of determining whether or not the number of the present loop coils 111, which are adjacent to each other, and in which the number of times of excess reaches the second number of times, is equal to or more than the first count (process of step S606) may also be carried out before the process of determining whether or not the number of times of excess in the selected loop coil 111 reaches the first number of times (process of step S605).

When determining that the number of times of excess in the selected loop coil 111 reaches the first number of times (step S605: YES), or determining that the number of the present loop coils 111, which are adjacent to each other, and in which the number of times of excess reaches the second number of times, is equal to or more than the first count (step S606: YES), the detector 120 notifies a user of the detection of a foreign substance (step S607). When completing the process of step S607, the detector 120 instructs a power supply to stop transmission of electric power (step S608). The process of instructing the power supply 220 to stop the transmission of the electric power (process of step S608) may also carried out before the process of notifying the user of the detection of the foreign substance (process of step S607).

When determining that the number of the present loop coils 111, which are adjacent to each other, and in which the number of times of excess reaches the second number of times, is not equal to or not more than the first count (step S606: NO), the detector 120 determines whether or not the number of times of excess in the selected loop coil 111 is 0 (step S609). When determining that the number of times of excess in the selected loop coil 111 is not 0 (step S609: NO), the detector 120 sets a reservation flag for the selected loop coil 111 (step S610).

When determining that the number of times of excess in the selected loop coil 111 is 0 (step S609: YES), or completing the process of step S610, the detector 120 determines whether or not an instruction to end the foreign substance detection process is given (step S611). When determining that the instruction to end the foreign substance detection process is not given (step S611: NO), the detector 120 returns the process to step S603. When determining that the start instruction is not given (step S601: NO), completing the process of step S608, or determining that the instruction to end the foreign substance detection process is given (step S611: YES), the detector 120 returns the process to step S601.

In the present embodiment, when excess sensors of which the number is equal to or more than the first count are detected in the execution of one consecutive comparison process, the subsequent consecutive comparison processes are executed such that individual comparison processes for each of the excess sensors, which are detected in the consecutive comparison process, and of which the number is equal to or more than the first count, are executed in earlier order. Accordingly, the large foreign substance 10 can be immediately detected while maintaining the number of times of execution of the individual comparison processes for each sensor in accordance with the present embodiment.

### Embodiment 5

Embodiments 1 to 4 describe the examples in which the foreign substance detection device 100 is disposed in the electric power transmission device 200. Embodiment 5 describes an example in which a foreign substance detection device 101 is disposed in an electric power reception device 300. Description of structures and processes similar to those in Embodiments 1 to 4 will be omitted or simplified.

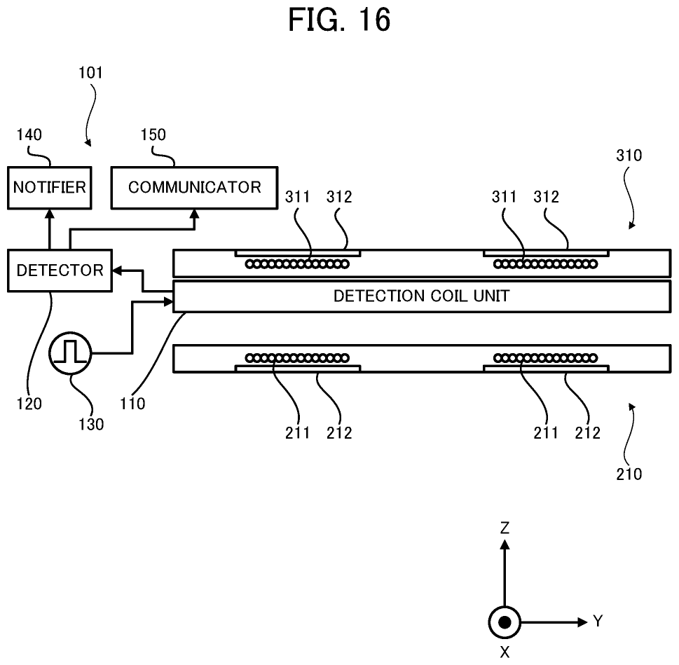

As illustrated in FIG. 16, the foreign substance detection device 101 includes a detection coil unit 110, a detector 120, a pulse generator 130, a notifier 140, and a communicator 150.

As illustrated in FIG. 16, the detection coil unit 110 is formed in a flat-plate shape, and is arranged below an electric power reception coil unit 310 so as to overlap an electric power reception coil 311 in planar view. The detector 120 determines whether or not a foreign substance is present in a region for detection on the basis of output values from loop coils 111 excited by applying pulsing voltage. The detector 120 controls the communicator 150 as well as the pulse generator 130 and the notifier 140.

The pulse generator 130 generates pulsing voltage for detecting a foreign substance, selects a loop coil 111, and applies the pulsing voltage to the loop coil 111. When the detector 120 detects a foreign substance, the notifier 140 notifies a user of the detection of the foreign substance. The communicator 150 transmits a signal for giving an instruction to stop transmission of electric power to an electric power transmission device 200 that transmits electric power to the electric power reception device 300 when the detector 120 determines that the foreign substance is present. In response to reception of the signal, a power supply 220 included in the electric power transmission device 200 stops supply of electric power to an electric power transmission coil unit 210 to stop the transmission of the electric power.

In the present embodiment, the foreign substance detection device 101 is disposed in the electric power reception device 300. Accordingly, a speed at which a specific foreign substance 10 is detected can be improved while suppressing false detection even when the foreign substance detection device 101 is disposed in the electric power reception device 300 from various viewpoints, in accordance with the present embodiment.

In the present embodiment, a signal for giving an instruction to stop transmission of electric power is transmitted from the electric power reception device 300 to the electric power transmission device 200 when the foreign substance 10 is detected. Accordingly, the transmission of the electric power can be stopped for safety in the case of the detection of the foreign substance 10 even when the foreign substance detection device 101 is disposed in the electric power reception device 300 from various viewpoints, in accordance with the present embodiment.

### Alternative Example

The embodiments of the present disclosure have been described above. However, modifications and applications according to various forms can be made when the present disclosure is carried out. In the present disclosure, it is optional to adopt which ones of the structures, functions, and operations described in the embodiments described above. In addition to the structures, functions, and operations described above, further structures, functions, and operations may also be adopted in the present disclosure. The embodiments described above can be freely combined as appropriate. The numbers of the components described in the embodiments described above can be adjusted as appropriate. It will be appreciated that materials, sizes, electrical characteristics, and the like that can be adopted in the present disclosure are not limited to those described in the embodiments described above.

Embodiments 1 to 5 describe the examples in which the sensors used in the detection of the foreign substance are the loop coils 111. Various sensors other than the loop coils 111 can be adopted as sensors used in detection of a foreign substance. For example, temperature sensors, infrared sensors, and the like can be adopted as the sensors used in the detection of the foreign substance. Embodiments 1 to 5 describe the examples in which the number of the sensors used in the detection of the foreign substances is 12. The number of sensors used in detection of a foreign substance is optional as long as being two or more.

Embodiments 1 to 5 describe the examples in which a value for comparison, which is compared with threshold values, is a difference value between an output value from a sensor and a reference value. The value for comparison need not be the difference value itself as long as being a value based on the difference value. For example, the value for comparison may be a value calculated by subjecting the difference value to predetermined computation, or may be a value determined from the difference value with reference to a predetermined table.

Embodiment 1 describes the example in which the notifier 140 notifies the user of the terminal device 600 of the detection of the foreign substance 10 by transmitting information, representing the detection of the foreign substance 10, to the terminal device 600. A method in which the user is notified of the detection of the foreign substance 10 is not limited to the example. For example, the notifier 140 may include a touch screen, a speaker, and/or the like, and may directly notify the user of the detection of the foreign substance 10 through screen display, voice output, or the like. The notifier 140 may be formed to transmit information, representing the detection of the foreign substance 10, to equipment included in the electric vehicle 700.

Embodiment 1 describes the example in which the threshold value of the number of times of excess is set in two stages depending on the count of the excess sensors, and Embodiment 2 describes the example in which the threshold value of the number of times of excess is set in three or more stages depending on the count of the excess sensors. The threshold value of the number of times of excess may be set in four or more stages depending on the count of the excess sensors. In this case, the threshold value of the number of times of excess is preferably decreased when the count of the excess sensors is increased.

Embodiment 1 describes the example in which the sensors, in which the number of times of excess is compared with the second number of times, and of which the number is the first count, are limited to sensors adjacent to each other. The sensors, in which the number of times of excess is compared with the second number of times, and of which the number is the first count, need not be sensors adjacent to each other. In this case, the presence of the foreign substance 10 is determined, for example, when the number of times of excess in sensors, which are arranged at positions spaced from each other, and of which the number is the first count exceeds the second number of times, as well as when the number of times of excess in sensors, which are arranged at positions adjacent to each other, and of which the number is the first count, exceeds the second number of times.

Embodiment 3 describes the example in which the individual comparison processes for each of the excess sensors of which the number is the first count are ended to restart the consecutive comparison processes by consecutively executing the individual comparison processes for each of the detected excess sensors, of which the number is the first count, at the predetermined number of times when the excess sensors of which the number is the first count is detected in the execution of one consecutive comparison process. The individual comparison processes for each of the excess sensors of which the number is the first count may be maintained while the difference value in each of the excess sensors of which the number is the first count exceeds the threshold value. In other words, the detector 120 may end the individual comparison processes for each of the excess sensors of which the number is the first count to restart the consecutive comparison processes in a case in which the difference value in at least one of the excess sensors of which the number is the first count is less than the threshold value, when consecutively executing the individual comparison processes for each of the excess sensors of which the number is the first count.

In such a case, the detector 120 may restart in the middle of the consecutive comparison processes, or may restart the consecutive comparison processes from the beginning, when restarting the consecutive comparison processes. For example, the consecutive comparison processes are discontinued, and the individual comparison processes for the loop coil 111B, the loop coil 111C, and the loop coil 111D are consecutively executed in a case in which the difference value in the loop coil 111B, the difference value in the loop coil 111C, and the difference value in the loop coil 111D exceed the threshold value when the consecutive comparison processes are executed in the initial execution order. In such a case, the individual comparison processes for the loop coil 111B, the loop coil 111C, and the loop coil 111D are ended when the difference value in the loop coil 111C is less than the threshold value. In this case, the detector 120 may restart the consecutive comparison processes from the individual comparison processes for the loop coil 111E, or may restart the consecutive comparison processes from the individual comparison processes for the loop coil 111A.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A foreign substance detection device comprising:
a plurality of sensors; and
a detector that repeatedly executes consecutive comparison processes in which individual comparison processes of comparing values for comparison based on output values from the sensors and a threshold value are executed in predetermined order for the plurality of sensors, and that determines presence or absence of a foreign substance based on comparison results of the individual comparison processes,
wherein in a case in which an excess sensor, among the plurality of sensors, which is a sensor in which the value for comparison exceeds the threshold value is present in one of the consecutive comparison processes, the detector determines that the foreign substance is present when a number of times of excess, which is a number of times at which the value for comparison exceeds the threshold value in the excess sensor reaches a first number of times; and in a case in which the excess sensors of which a number is a first count that is more than one are present in one of the consecutive comparison processes, the detector determines that the foreign substance is present when the number of times of excess in each of the excess sensors of which the number is the first count reaches a second number of times, which is less than the first number of times.

2. The foreign substance detection device according to claim 1, wherein the detector determines that the foreign substance is present when the number of times of excess in each of the excess sensors of which the number is a second count reaches a third number of times that is less than the second number of times in a case in which the excess sensors of which the number is the second count that is more than the first count are present in one of the consecutive comparison processes.

3. The foreign substance detection device according to claim 1, wherein when the excess sensors of which the number is the first count are detected in execution of one of the consecutive comparison processes, the detector consecutively executes the individual comparison processes for each of the detected excess sensors of which the number is the first count.

4. The foreign substance detection device according to claim 3, wherein the detector restarts the consecutive comparison processes when the value for comparison in at least one of the excess sensors of which the number is the first count is less than the threshold value in a case in which the individual comparison processes for each of the detected excess sensors of which the number is the first count are consecutively executed.

5. The foreign substance detection device according to claim 1, wherein
when the excess sensors of which the number is equal to or more than the first count are detected in execution of one of the consecutive comparison processes, the detector executes the subsequent consecutive comparison processes such that the individual comparison processes for each of the excess sensors, which are detected in the consecutive comparison process, and of which the number is equal to or more than the first count, are executed in earlier order.

6. The foreign substance detection device according to claim 1, further comprising a notifier that notifies at least one of a user and predetermined equipment of presence of the foreign substance when the detector determines that the foreign substance is present.

7. An electric power transmission device comprising:
an electric power transmission coil formed by winding a conductive wire; and
the foreign substance detection device according to claim 1.

8. The electric power transmission device according to claim 7, further comprising a power supply that supplies alternating-current power to the electric power transmission coil,
wherein the power supply stops supply of the alternating-current power to the electric power transmission coil when the detector determines that the foreign substance is present.

9. An electric power reception device comprising:
an electric power reception coil formed by winding a conductive wire; and
the foreign substance detection device according to claim 1.

10. The electric power reception device according to claim 9, further comprising a communicator that transmits a signal for giving an instruction to stop transmission of electric power to an electric power transmission device that transmits electric power to the electric power reception device when the detector determines that the foreign substance is present.

11. An electric power transmission system comprising:
the electric power transmission device according to claim 7; and
an electric power reception device that receives electric power from the electric power transmission device.

12. An electric power transmission system comprising:
the electric power reception device according to claim 9; and
an electric power transmission device that transmits electric power to the electric power reception device.
